(19) United States
(12) Patent Application Publication
(10) Pub. No.: US 2020/0094875 A1
(43) Pub. Date: Mar. 26, 2020

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventor: Yoshitaka Mimura, Wako-shi (JP)

(21) Appl. No.: 16/576,878

(22) Filed: Sep. 20, 2019

(30) Foreign Application Priority Data
Sep. 25, 2018 (JP) 2018-179223

(51) Int. Cl. B62D 15/02; B60W 30/18; B60R 1/12

(52) U.S. Cl. CPC B62D 15/0255; B60W 2710/20; B60R 1/1207; B60W 30/18163

(57) ABSTRACT

A vehicle control device includes: a surrounding recognizer that is configured to recognize a surrounding environment of a vehicle; a lane change controller that is configured to perform lane change control of the vehicle by controlling at least steering of the vehicle; a side mirror that is configured to reflect an image of a landscape of a rear side of the vehicle including an adjacent lane adjacent to an own lane in which the vehicle is running and allows a vehicle occupant of the vehicle to visually recognize the image; a display unit that is disposed in the side mirror; and a display controller that is configured to cause the display unit to display a notification image used for giving a notification of execution of the lane change control.

### CROSS-REFERENCE TO RELATED APPLICATION

Priority is claimed on Japanese Patent Application No. 2018-179223, filed Sep. 25, 2018, the content of which is incorporated herein by reference.

### BACKGROUND

### Field of the Invention

The present invention relates to a vehicle control device, a vehicle control method, and a storage medium.

### Description of Related Art

Conventionally, technologies for displaying information of a surrounding environment on a display included in a vehicle are known (for example, Japanese Unexamined Patent Application, First Publication No. 2005-332218).

### SUMMARY

Meanwhile, in recent years, automated control of vehicles has been researched. In relation to this, technologies for automatedly causing a vehicle to perform a lane change are known. In a conventional technology, although information of a surrounding environment of a vehicle can be displayed on a display, display of a control state of the vehicle is not performed. As a result, there are cases in which vehicle occupants of a subject vehicle and other vehicles, in other words, traffic participants, feel anxiety.

An aspect of the present invention is in consideration of such situations, and one objective thereof is to provide a vehicle control device, a vehicle control method, and a storage medium capable of prompting a driver of a vehicle to monitor surroundings while giving a feeling of security to traffic participants.

A vehicle control device, a vehicle control method, and a storage medium according to the present invention employ the following configurations.

(1): A vehicle control device according to one aspect of the present invention includes: a surrounding recognizer that is configured to recognize a surrounding environment of a vehicle; a lane change controller that is configured to perform lane change control of the vehicle by controlling at least steering of the vehicle; a side mirror that is configured to reflect an image of a landscape of a rear side of the vehicle including an adjacent lane adjacent to an own lane in which the vehicle is running and allows a vehicle occupant of the vehicle to visually recognize the image; a display unit that is disposed in the side mirror; and a display controller that is configured to cause the display unit to display a notification image used for giving a notification of execution of the lane change control.

(2): In the aspect (1) described above, the display controller is configured to cause the display unit to display the notification image at a timing at which the lane change control is performed by the lane change controller.

(3): In the aspects (1) described above, the display controller is configured to cause the display unit to display a first notification image representing that a lane change is planned, a second notification image representing a space searching process accompanying the lane change, and a third notification image representing being in the middle of the lane change in mutually different display forms.

(4): In the aspects (1) described above, the vehicle control device further includes a illuminator that is disposed in an outer edge of the side mirror, and the display controller is configured to give a notification of the lane change of the vehicle by turning the illuminator on.

(5): A vehicle control method according to one aspect of the present invention is a vehicle control method using a computer mounted in a vehicle including a side mirror that is configured to reflect an image of a landscape of a rear side of the vehicle including an adjacent lane adjacent to an own lane in which the vehicle is running and allows a vehicle occupant of the vehicle to visually recognize the image and a display unit that is disposed in the side mirror, the vehicle control method including: recognizing a surrounding environment of the vehicle; performing lane change control of the vehicle by controlling at least steering of the vehicle; and causing the display unit to display a notification image used for giving a notification of execution of the lane change control.

(6): A storage medium according to one aspect of the present invention is a storage medium having a program stored thereon, the program causing a computer mounted in the vehicle including a side mirror that is configured to reflect an image of a landscape of a rear side of a vehicle including an adjacent lane adjacent to an own lane in which the vehicle is running and allows a vehicle occupant of the vehicle to visually recognize the image and a display unit that is disposed in the side mirror and executes: recognizing a surrounding environment of the vehicle; performing lane change control of the vehicle by controlling at least steering of the vehicle; and causing the display unit to display a notification image used for giving a notification of execution of the lane change control.

According to the aspects (1) to (6) described above, a driver of a vehicle can be prompted to monitor surroundings while a feeling of security is given to a traffic participant.

According to the aspect (3) described above, information can be presented to a vehicle occupant more easily.

### BRIEF DESCRIPTION OF THE DRAWINGS

FIG. 1 is a configuration diagram of a vehicle control system according to a first embodiment;

FIG. 2 is a diagram showing one example of the configuration of a right side mirror according to the first embodiment;

FIG. 3 is a functional configuration diagram of a first controller and a second controller;

FIG. 4 is a diagram (1) showing a situation in which a subject vehicle is caused to perform a lane change;

FIG. 5 is a diagram (2) showing a situation in which the subject vehicle is caused to perform a lane change;

FIG. 6 is a diagram (3) showing a situation in which the subject vehicle is caused to perform a lane change;

FIG. 7 is a diagram showing one example of a first notification image;

FIG. 8 is a diagram showing one example of a second notification image;

FIG. 9 is a diagram showing one example of a fifth notification image;

FIG. 10 is a flowchart showing one example of the flow of an operation of a driving support controller according to the first embodiment;

FIG. 11 is a configuration diagram of a vehicle control system according to a second embodiment;

FIG. 12 is a diagram showing one example of the configuration of a right side mirror SMRa according to a modified example; and

FIG. 13 is a diagram showing one example of the hardware configuration of an automated driving control device.

### DESCRIPTION OF EMBODIMENTS

Hereinafter, a vehicle control device, a vehicle control method, and a storage medium according to embodiments of the present invention will be described with reference to the drawings.

### [Entire Configuration]

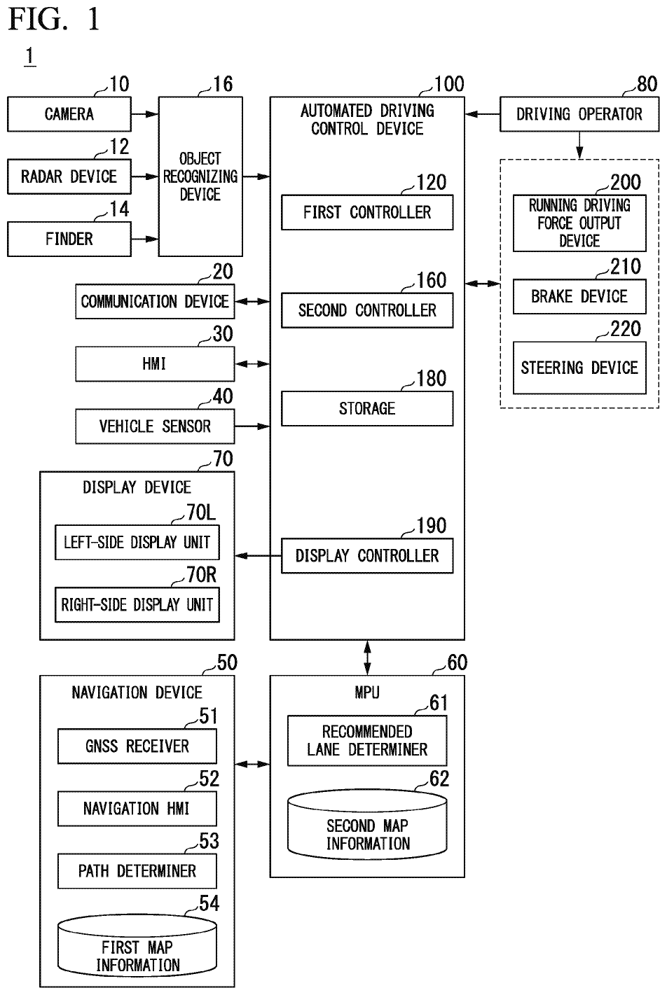

FIG. 1 is a configuration diagram of a vehicle control system 1 according to a first embodiment. A vehicle in which the vehicle control system 1 is mounted (hereinafter, referred to as a subject vehicle M) is, for example, a vehicle having two wheels, three wheels, four wheels, or the like, and a driving source thereof is an internal combustion engine such as a diesel engine or a gasoline engine, an electric motor, or a combination thereof. The electric motor operates using power generated using a power generator connected to an internal combustion engine or power discharged from a secondary cell or a fuel cell.

The vehicle control system 1, for example, includes a camera 10, a radar device 12, a finder 14, an object recognizing device 16, a communication device 20, a human machine interface (HMI) 30, a vehicle sensor 40, a navigation device 50, a map positioning unit (MPU) 60, a display device 70, a driving operator 80, an automated driving control device 100, a running driving force output device 200, a brake device 210, and a steering device 220. Such devices and units are interconnected using a multiplex communication line such as a controller area network (CAN) communication line, a serial communication line, a radio communication network, or the like. The configuration shown in FIG. 1 is merely one example, and thus parts of the configuration may be omitted or other additional components may be added.

The camera 10, for example, is a digital camera using a solid-state imaging device such as a charge coupled device (CCD) or a complementary metal oxide semiconductor (CMOS). One or a plurality of cameras 10 are installed at arbitrary places on the subject vehicle M. In the case of forward imaging, the camera 10 is installed at an upper part of a front windshield, a rear face of a rear-view mirror, or the like. The camera 10, for example, repeatedly images the vicinity of the subject vehicle M periodically. The camera 10 may be a stereo camera.

The radar device 12 emits radio waves such as millimeter waves to the vicinity of the subject vehicle M and detects at least a position of (a distance and an azimuth to) an object by detecting radio waves (reflected waves) reflected by the object. One or a plurality of radar devices 12 are installed at arbitrary places on the subject vehicle M. The radar device 12 may detect a position and a speed of an object using a frequency modulated continuous wave (FM-CW) system.

The finder 14 is a light detection and ranging or a laser imaging detection and ranging (LIDAR) finder that detects a distance to a target by measuring light scattered from emitted light. One or a plurality of finders 14 are installed at arbitrary places in the subject vehicle M.

The object recognizing device 16 performs a sensor fusion process on results of detection using some or all of the camera 10, the radar device 12, and the finder 14, thereby recognizing a position, a type, a speed, a moving direction, and the like of an object. Objects to be recognized, for example, are objects of types such as a vehicle, a guard rail, an electric post, pedestrians, and a road mark. The object recognizing device 16 outputs a result of the recognition to the automated driving control device 100. The object recognizing device 16 may output a part of information input from the camera 10, the radar device 12, or the finder 14 to the automated driving control device 100 as it is.

The communication device 20, for example, communicates with other vehicles present in the vicinity of the subject vehicle M using a cellular network, a Wi-Fi network, Bluetooth (registered trademark), dedicated short range communication (DSRC), or the like or communicates with various server apparatuses through a radio base station.

The HMI 30 presents various kinds of information to a vehicle occupant of the subject vehicle M and accepts an input operation from a vehicle occupant. The HMI 30 includes various display devices, a speaker, a buzzer, a touch panel, switches, keys, and the like.

The vehicle sensor 40, for example, includes a vehicle speed sensor detecting a speed of the subject vehicle M, an acceleration sensor detecting an acceleration, a yaw rate sensor detecting an angular velocity around a vertical axis, an azimuth sensor detecting a direction of the subject vehicle M, and the like. Each sensor included in the vehicle sensor 40 outputs a detection signal representing a detection result to the automated driving control device 100.

The navigation device 50, for example, includes a global navigation satellite system (GNSS) receiver 51, a navigation HMI 52, and a path determiner 53. The navigation device 50 stores first map information 54 in a storage device such as a hard disk drive (HDD) or a flash memory. The GNSS receiver 51 identifies a position of a subject vehicle M on the basis of signals received from GNSS satellites. The position of the subject vehicle M may be identified or complemented by an inertial navigation system (INS) using an output of the vehicle sensor 40. The navigation HMI 52 includes a display device, a speaker, a touch panel, a key, and the like. A part or the whole of the navigation HMI 52 and the HMI 30 described above may be configured to be shared. The path determiner 53, for example, determines a path to a destination input by a vehicle occupant using the navigation HMI 52 (hereinafter referred to as a path on a map) from a position of the subject vehicle M identified by the GNSS receiver 51 (or an input arbitrary position) by referring to the first map information 54. The first map information 54, for example, is information in which a road form is represented by respective links representing roads and respective nodes connected using the links. The first map information 54 may include a curvature of each road, point of interest (POI) information, and the like. A path on the map is output to the MPU 60. The navigation device 50 may perform path guiding using the navigation HMI 52 on the basis of a path on the map. The navigation device 50, for example, may be realized using a function of a terminal device such as a smartphone or a tablet terminal held by a vehicle occupant. The navigation device 50 may transmit a current position and a destination to a navigation server through the communication device 20 and acquire a path equivalent to the path on the map from the navigation server.

The MPU 60, for example, includes a recommended lane determiner 61 and stores second map information 62 in a storage device such as an HDD or a flash memory. The recommended lane determiner 61 divides the path on the map provided from the navigation device 50 into a plurality of blocks (for example, divides the route into blocks of 100 [m] in the advancement direction of the vehicle) and determines a recommended lane for each block by referring to the second map information 62. The recommended lane determiner 61 determines in which of lanes numbered from the left side to run. In a case in which there is a branching place in the path on the map, the recommended lane determiner 61 determines a recommended lane such that the subject vehicle M can run along a reasonable path for advancement to a branching destination.

The second map information 62 is map information having higher accuracy than the first map information 54. The second map information 62, for example, includes information on the centers of respective lanes or information on boundaries between lanes and the like. In addition, in the second map information 62, road information, traffic regulation information, address information (addresses and postal codes), facility information, telephone number information, and the like may be included. The second map information 62 may be updated as needed by the communication device 20 communicating with another device.

The display device 70, for example, presents various kinds of information to a vehicle occupant of the subject vehicle M and is realized by various display devices such as a liquid crystal display (LCD) and an organic electroluminescence (EL) display, and the like, and the display device 70 displays various images on the basis of control of the automated driving control device 100. In this embodiment, a left-side display unit 70L and a right-side display unit 70R are included in the display device 70. The left-side display unit 70L is disposed in a left side mirror of the subject vehicle M, and the right-side display unit 70R is disposed in a right side mirror of the subject vehicle M.

### [Configuration of Right Side Mirror SMR]

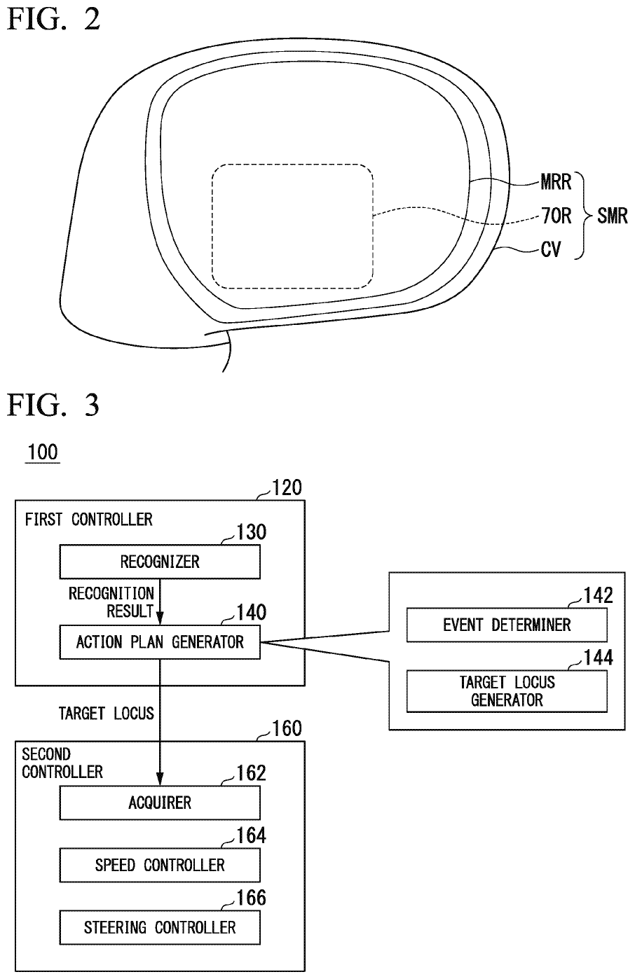

FIG. 2 is a diagram showing one example of the configuration of the right side mirror SMR according to the first embodiment. The right side mirror SMR shown in FIG. 2 is a side mirror that is disposed on the right side of the subject vehicle M. The right side mirror SMR and a side mirror disposed on the left side of the subject vehicle M (hereinafter, referred to as a left side mirror SML) have the same configuration. Thus, in the following description, the right side mirror SMR will be described, and the left side and the right side are interchanged in the following description for the left side mirror SML.

The right side mirror SMR includes a mirror part MRR, a cover part CV, and a right-side display unit 70R. The mirror part MRR is formed in a plate shape and has a front face and a rear face. A rear face of the mirror unit MRR is covered with the cover part CV. The right-side display unit 70R is disposed between the mirror part MRR and the cover part CV and is disposed to be brought into contact with or approach the rear face of the mirror part MRR. The right-side display unit 70R approaching the rear face, for example, represents that the right-side display unit 70R faces the rear face of the mirror part MRR at a space that is within several [mm]. The mirror part MRR is formed by a plurality of layers of which materials are different from each other. The mirror part MRR, for example, reflects at least a part of light incident from the front side and transmits at least a part of light incident from the rear side. As a result, the mirror part MRR has a function as a mirror surface and a function as a cover transmitting light. In other words, the right side mirror SMR reflects an image of a landscape of the rear right side of the subject vehicle M including an adjacent lane adjacent to an own lane in which the subject vehicle M is running and allows a vehicle occupant of the subject vehicle M to visually recognize the image and allows an observer to be able to visually recognize an image displayed by the right-side display unit 70R from the front side. The observer, for example, is a vehicle occupant of the subject vehicle M or a vehicle occupant of other vehicle m running on the rear right side of the subject vehicle M in the adjacent lane.

The mirror part MRR enables an observer to visually recognize at least a part of the display device 70 and may have a configuration including a hole part passing through the front face and the rear face of the mirror part MRR. In such a case, in a case in which the front face of the mirror part MRR is a mirror surface, it may not be formed to transmit at least a part of light incident from the rear face. The display device 70 may be attached to the front face of the mirror part MRR, and the display device 70 may have a light reflecting property of some degree. The display device 70 may be attached to the front face of the mirror part MRR, and the display device 70 may have a light transmitting property. In such a case, the display device 70 is realized by a transparent liquid crystal, an organic EL, or the like, and light transmitted through the display device 70 is reflected by the mirror part MRR and exits to the front side. The display device 70 may be formed to project to the upper side, the lower side, or the outer side of the mirror part MRR.

Referring back to FIG. 1, the driving operator 80, for example, includes various operators such as the steering wheel, the acceleration pedal, the brake pedal, and the shift lever described above. In each operator of the driving operator 80, for example, an operation detector that detects the amount of operation performed by a vehicle occupant is mounted. The operation detector detects the amount of depression of the acceleration pedal or the brake pedal, the position of the shift lever, a steering angle or a steering torque of a steering wheel, or the like. Then, the operation detector outputs a detection signal representing detection results to the automated driving control device 100 or the running driving force output device 200 and one or both of the brake device 210 and the steering device 220.

Before description of the automated driving control device 100, the running driving force output device 200, the brake device 210, and the steering device 220 will be described. The running driving force output device 200 outputs a running driving force (torque) for enabling the subject vehicle M to run to driving wheels. The running driving force output device 200, for example, includes a combination of an internal combustion engine, an electric motor, and a transmission, and a power electronic control unit (ECU) controlling these. The power ECU controls the components described above in accordance with information input from the automated driving control device 100 or information input from the driving operator 80.

The brake device 210, for example, includes a brake caliper, a cylinder that delivers hydraulic pressure to the brake caliper, an electric motor that generates hydraulic pressure in the cylinder, and a brake ECU. The brake ECU performs control of the electric motor in accordance with information input from the automated driving control device 100 or information input from the driving operator 80 such that a brake torque according to a brake operation is output to each vehicle wheel. The brake device 210 may include a mechanism delivering hydraulic pressure generated in accordance with an operation on the brake pedal included in the driving operators 80 to the cylinder through a master cylinder as a backup. The brake device 210 is not limited to the configuration described above and may be an electronically-controlled hydraulic brake device that delivers hydraulic pressure in the master cylinder to a cylinder by controlling an actuator in accordance with information input from the automated driving control device 100.

The steering device 220, for example, includes a steering ECU and an electric motor. The electric motor, for example, changes the direction of the steering wheel by applying a force to a rack and pinion mechanism. The steering ECU changes the direction of the steering wheel by driving an electric motor in accordance with information input from the automated driving control device 100 or information input from the driving operator 80.

### [Configuration of Automated Driving Control Device 100]

The automated driving control device 100, for example, includes a first controller 120, a second controller 160, a storage 180, and a display controller 190. Each of the first controller 120 and the second controller 160, for example, is realized by a hardware processor such as a central processing unit (CPU) executing a program (software). Some or all of these constituent elements may be realized by hardware (a circuit unit; including circuitry) such as a large scale integration (LSI), an application specific integrated circuit (ASIC), a field-programmable gate array (FPGA), or a graphics processing unit (GPU) or may be realized by software and hardware in cooperation. The program may be stored in a storage device such as an HDD, a flash memory, or the like of the storage 180 in advance or may be stored in a storage medium such as a DVD or a CD-ROM that can be loaded or unloaded and installed in the HDD or the flash memory of the automated driving control device 100 by loading the storage medium into a drive device.

FIG. 3 is a functional configuration diagram of the first controller 120 and the second controller 160. The first controller 120, for example, includes a recognizer 130 and an action plan generator 140. The first controller 120, for example, simultaneously realizes functions using artificial intelligence (AI) and functions using a model provided in advance. For example, a function of “recognizing an intersection” may be realized by executing recognition of an intersection using deep learning or the like and recognition based on conditions given in advance (there are a signal, a road marking, and the like that can be used for pattern matching) at the same time and comprehensively evaluating both recognitions by assigning scores to them. Accordingly, the reliability of automated driving is secured.

The recognizer 130 recognizes states such as positions, speeds, and accelerations of objects present in the vicinity of the subject vehicle M on the basis of information input from the camera 10, the radar device 12, and the finder 14 through the object recognizing device 16. Other vehicles are included in the objects. For example, the position of an object is recognized as a position on absolute coordinates having a representative point (a center of gravity, a driving shaft center, or the like) of the subject vehicle M as an origin and is used for control. The position of an object may be represented using a center of gravity, a corner, or the like of the object and may be represented using a represented area. A “state” of an object may include an acceleration, a jerk, or an “action state” (for example, whether or not the object is changing lanes or will change lanes) of the object.

For example, the recognizer 130, for example, recognizes a lane in which the subject vehicle M is running (running lane). For example, the recognizer 130 recognizes a running lane by comparing a pattern of road partition lines (for example, an arrangement of solid lines and broken lines) acquired from the second map information 62 with a pattern of road partition lines in the vicinity of the subject vehicle M recognized from an image captured by the camera 10. The recognizer 130 may recognize a running lane by recognizing running road boundaries (road boundaries) including road partition lines, road shoulders, curbstones, a median strip, guard rails, and the like instead of road partition lines. In this recognition, the location of the subject vehicle M acquired from the navigation device 50 or a processing result acquired by the INS may be taken into account as well. The recognizer 130 recognizes a temporary stop line, an obstacle, a red light, a tollgate, and other road events.

When recognizing a running lane, the recognizer 130 recognizes a position and a posture of the subject vehicle M with respect to the running lane. The recognizer 130, for example, may recognize a deviation of a representative point of the subject vehicle M from the center of the lane and an angle formed with respect to a line in which the center of the lane in the advancement direction of the subject vehicle M is aligned as a relative position and a posture of the subject vehicle M with respect to the running lane. Instead of this, the recognizer 130 may recognize the position of the representative point of the subject vehicle M with respect to one side end part (a road partition line or a road boundary) of the running lane or the like as a relative position of the subject vehicle M with respect to the running lane. The recognizer 130 is one example of a “surrounding recognizer.”

The action plan generator 140 automatically (without depending on a driver's operation) generates a target locus along which the subject vehicle M will run in the future such that the subject vehicle basically can run on a recommended lane determined by the recommended lane determiner 61 and can respond to a surrounding situation of the subject vehicle M. The target locus, for example, includes a speed element. For example, the target locus is represented as a sequence of places (locus points) at which the subject vehicle M will arrive. A locus point is a place at which the subject vehicle M will arrive for respective predetermined running distances (for example, about every several [m]) as distances along the road, and separately from that, a target speed and a target acceleration for each of predetermined sampling times (for example, a fraction of a [sec]) are generated as a part of the target locus. A locus point may be a position at which the subject vehicle M will arrive at the sampling time for each predetermined sampling time. In such a case, information of a target speed or a target acceleration is represented using intervals between the locus points.

When a target locus is generated, the action plan generator 140 may set an event of automated driving. As events of automated driving, there are a constant-speed running event, a low-speed running-behind event in which the subject vehicle runs behind a preceding vehicle at a predetermined vehicle speed (for example, 60 [km]) or less, a lane changing event, a branching event, a merge event, an overtaking event, and the like. The action plan generator 140 generates a target locus according to an operated event.

The action plan generator 140, for example, includes an event determiner 142 and a target locus generator 144. The event determiner 142 determines an event of automated driving in a path along which recommended lanes are determined. An event is information that defines a running form of the subject vehicle M.

As events, for example, a constant-speed running event in which the subject vehicle M is caused to run at a constant speed in the same running lane, a running-behind event in which the subject vehicle M is caused to follow a vehicle that is present within a predetermined distance (for example, within 100 [m]) in front of the subject vehicle M and is the closest to the subject vehicle M (hereinafter, referred to as a preceding vehicle as is necessary), a lane changing event in which the subject vehicle M is caused to change the lane from the own lane to an adjacent lane, a branching event in which the subject vehicle M is caused to branch to a lane on a destination side at a branching point of a road, a merging event in which the subject vehicle M is caused to merge into a main line at a merging point, and a taking over event in which the subject vehicle is caused to end automated driving and switch to manual driving, and the like are included. Here, the “following running,” for example, may have a running form in which an inter-vehicle distance (relative distance) between the subject vehicle M and a preceding vehicle is maintained to be constant or may have a running form in which the subject vehicle M is caused to run at the center of the own lane in addition to maintenance of an inter-vehicle distance between the subject vehicle M and a vehicle running head to be constant. In the events, for example, a takeover event in which the subject vehicle M is caused to temporarily change lanes to an adjacent lane, take over a preceding vehicle in the adjacent lane, and then change lanes to the original lane again, or causes the subject vehicle M to approach a partition line partitioning the own lane, take over a preceding vehicle within the same lane without changing the lane of the subject vehicle M to the adjacent lane, and then return to the original position (for example, the lane center), an avoidance event in which the subject vehicle M is caused to perform at least one of braking and steering for avoiding an obstacle present in front of the subject vehicle M, and the like may be included.

The event determiner 142, for example, may change an event that has already been determined for a current section to another event or determine a new event for the current section in accordance with a situation of the vicinity recognized by the recognizer 130 at the time of running of the subject vehicle M.

The event determiner 142, for example, may change an event that has already been determined for a current section to another event or determine a new event for the current section in accordance with an operation of a vehicle occupant on an in-vehicle device. For example, in a case in which a turn indicator lever (a direction indicator) is operated by a vehicle occupant, the event determiner 142 may change an event that has already been determined for a current section to a lane changing event or newly determine a lane changing event for the current section.

The target locus generator 144 generates a future target locus causing the subject vehicle M to run in a recommended lane determined by the recommended lane determiner 61 in principle and, in order to respond to situations of the vicinity when the subject vehicle M runs in the recommended lane, causing the subject vehicle M to automatedly (not depending on an operation of a driver) run in a running form defined by an event. In the target locus, for example, a position element determining a future position of the subject vehicle M and a speed element determining a future speed and the like of the subject vehicle M are included.

For example, the target locus generator 144 determines a plurality of points (locus points) to be sequentially reached by the subject vehicle M as position elements of the target locus. Locus points are points to be reached by the subject vehicle M for every predetermined running distance (for example, about several [m]). The predetermined running distance, for example, may be calculated in accordance with a distance along the road when the subject vehicle advances along a path.

The target locus generator 144 determines a target speed and a target acceleration for every predetermined sampling time (for example, a fraction of [sec]) as speed elements of the target locus. A locus point may be, for every predetermined sampling time, may be a position to be reached by the subject vehicle M at the sampling time. In this case, a target speed and a target acceleration may be determined in accordance with intervals of sampling times and locus points. The target locus generator 144 outputs information representing the generated target locus to the second controller 160.

The second controller 160 controls the running driving force output device 200, the brake device 210, and the steering device 220 such that the subject vehicle M passes through a target locus generated by the action plan generator 140 at a scheduled time.

The second controller 160, for example, includes an acquirer 162, a speed controller 164, and a steering controller 166. The acquirer 162 acquires information of a target locus (locus points) generated by the action plan generator 140 and stores the acquired target locus in the storage 180. The speed controller 164 controls the running driving force output device 200 or the brake device 210 on the basis of speed elements accompanying the target locus stored in the memory. The steering controller 166 controls the steering device 220 in accordance with a bending state of the target locus stored in the memory. The processes of the speed controller 164 and the steering controller 166, for example, are realized by a combination of feed-forward control and feedback control. As one example, the steering controller 166 executes feed-forward control according to a curvature of a road disposed in front of the subject vehicle M and feedback control based on a deviation from a target locus in combination. A combination of the action plan generator 140 and the second controller 160 is one example of a “lane change controller.”

### [Lane Changing Event]

Hereinafter, a lane changing event will be described. The event determiner 142, for example, determines execution of a lane changing event in accompaniment with a change in the course accompanying movement in a direction toward a destination or overtaking of a preceding vehicle. In a case in which the execution of a lane changing event is determined by the event determiner 142, the target locus generator 144 executes an automated lane change (hereinafter, referred to as an auto lane change (ALC)).

When automated driving control is performed by the automated driving control device 100, in a case in which a turn indicator is operated by a vehicle occupant of the subject vehicle M, a lane changing event may be started.

The target locus generator 144 determines whether or not a lane change to a movement side can be performed using the ALC. The target locus generator 144, for example, executes an ALC in a case in which ALC start conditions such as a condition that an obstacle including any other vehicle is not present in a lane that is a lane change destination, a condition that a partition line LM partitioning a lane that is a lane change destination and an own lane is not a road mark representing prohibition of a lane change (prohibition of run-over), a condition that a lane that is a lane change destination is recognized, a condition that the road is not a curved road, a condition that another driving support control having a priority level higher than that of the ALC is not performed, and a condition that a predetermined time or more has elapsed from the start of operations of speed adjustment support control and lane keeping support control are satisfied. Here, another driving support control having a priority level higher than that of the ALC, for example, is control for urgently avoiding an obstacle.

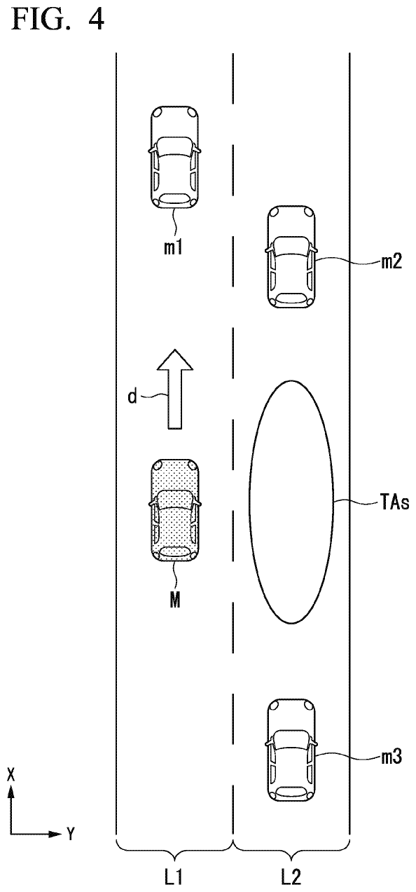

Here, details of the ALC will be described. FIGS. 4 to 6 are diagrams showing the ALC. In the drawing, a lane L1 represents an own lane, and a lane L2 represents an adjacent lane that is adjacent to the own lane to the right side. A direction X represents an extending direction of a road or an advancement direction of the subject vehicle M, and a direction Y represents a road width direction that is orthogonal to the direction X.

In the example shown in FIG. 4, the target locus generator 144 selects two other vehicles among a plurality of other vehicles running in the adjacent lane L2 and sets a lane change target position TAs between the selected two other vehicles. The lane change target position TAs is a position of a target lane change destination and is a relative position between the subject vehicle M and two other vehicles. In the example shown in the drawing, since an other vehicle m2 and an other vehicle m3 are running on the adjacent lane, the target locus generator 144 sets a lane change target position TAs between the other vehicle m2 and the other vehicle m3. In a case in which there is only one other vehicle in the adjacent lane L2, the target locus generator 144 may set a lane change target position TAs to an arbitrary position on a side in front or in back of the other vehicle.

In a case in which there is no other vehicle in the adjacent lane L2, the target locus generator 144 may set the lane change target position TAs to an arbitrary position on the adjacent lane L2. Hereinafter, an other vehicle running immediately before the lane change target position TAs in the adjacent lane (in the example shown in the drawing, the other vehicle m2) will be referred to as a front reference vehicle, and the other vehicle running immediately after the lane change target position TAs in the adjacent lane (in the example shown in the drawing, the other vehicle m3) will be referred to as a rear reference vehicle.

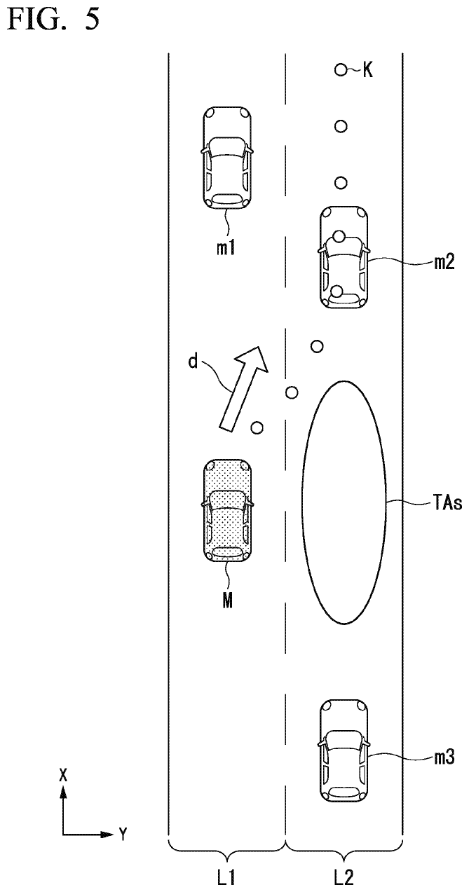

When the lane change target position TAs is set, the target locus generator 144 generates a plurality of candidates for a target locus for changing the lane of the subject vehicle M. In the example shown in FIG. 5, the target locus generator 144 assumes that each of the other vehicle m1 that is a preceding vehicle, the other vehicle m2 that is a front reference vehicle, and the other vehicle m3 that is a rear reference vehicle runs in accordance with a predetermined speed model and generates a plurality of candidates for a target locus on the basis of speed models of these three vehicles and a speed of a subject vehicle M such that the subject vehicle M does not interfere with the other vehicle m1 and is present at a lane change target position TAs between the other vehicle m2 and the other vehicle m3 at a certain time in the future.

For example, the target locus generator 144 smoothly connects from a current position of the subject vehicle M to a position of the other vehicle m2 at a certain time in the future, the center of a lane that is a lane change destination, and an end point of the lane change using a polynomial curve such as a spline curve and arranges a predetermined number of locus points K at equal intervals or unequal intervals on this curve. At this time, the target locus generator 144 generates a plurality of candidates for a target locus such that at least one locus point K is disposed within the lane change target position TAs.

Then, the target locus generator 144 selects an optimal target locus among the plurality of generated candidates for the target locus. The optimal target locus, for example, is a target locus in which a yaw rate, which is predicted to be generated when the subject vehicle M is caused to run on the basis of the target locus, is lower than a threshold, and a speed of the subject vehicle M is within a predetermined speed range. The threshold of the yaw rate, for example, is set to a yaw rate of a degree at which an excessive load (an acceleration in the vehicle width direction becomes equal to or higher than a threshold) is not generated for a vehicle occupant when a lane change is performed. The predetermined speed range, for example, is set to a speed range of about 70 to 110 [km/h].

In the following description, a situation until a lane change target position TAs is set (in other words, a situation in which an ALC is planned) will be described as a “first situation.” In the first situation, the setting of a lane change target position TAs is one example of a “lane change being planned.”

When the lane change target position TAs is set, and a target locus for changing the lane of the subject vehicle M to the lane change target position TAs is generated, the target locus generator 144 determines whether or not a lane change to the lane change target position TAs (in other words, between the other vehicle m2 and the other vehicle m3) can be performed.

For example, the target locus generator 144 sets a prohibition area RA prohibiting the presence of an other vehicle in the adjacent lane L2, and, in a case in which at least a part of an other vehicle is not present in the prohibition area RA, and each of times-to-collision (TTC) between the subject vehicle M and the other vehicle m2 and the other vehicle m3 is longer than a threshold, it is determined that a lane change can be performed. This determination condition is one example in a case in which a lane change target position TAs is set on a lateral side of the subject vehicle M.

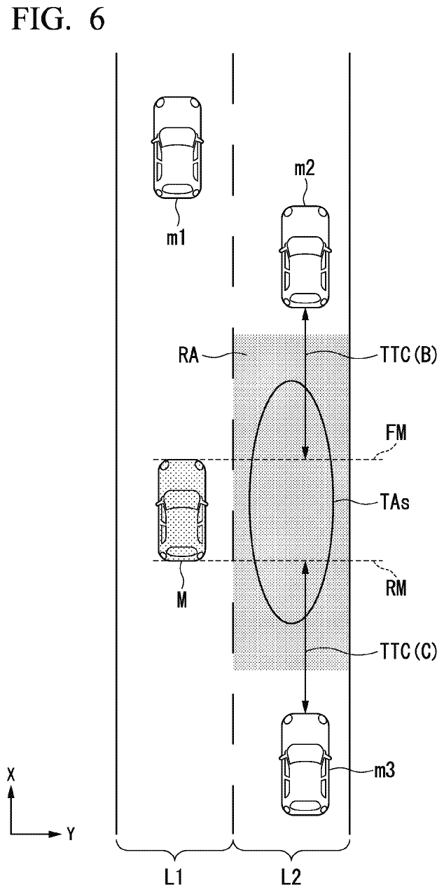

As shown in FIG. 6, for example, the target locus generator 144 projects the subject vehicle M to an adjacent lane L2 that is a lane change destination and sets a prohibition area RA having a predetermined margin distance before and after the prohibition area. The prohibition area RA is set as an area extending from one end to the other end of the adjacent lane L2 in the horizontal direction (direction Y).

In a case in which no other vehicle is present inside the prohibition area RA, for example, the target locus generator 144 sets a virtual extension line FM and a virtual extension line RM acquired by extending a front end and a rear end of the subject vehicle M on the side of the adjacent lane L2 that is a lane change destination. The target locus generator 144 calculates a time-to-collision TTC(B) between the extension line FM and the other vehicle m2 and a time-to-collision TTC(C) between the extension line RM and the other vehicle m3. The time-to-collision TTC(B) is a time derived by dividing a distance between the extension line FM and the other vehicle m2 by a relative speed between the subject vehicle M and the other vehicle m2. The time-to-collision TTC(C) is a time derived by dividing a distance between the extension line RM and the other vehicle m3 by a relative speed between the subject vehicle M and the other vehicle m3. In a case in which the time-to-collision TTC(B) is longer than a threshold Th(B), and the time-to-collision TTC(C) is longer than a threshold Th(C), the target locus generator 144 determines that a lane change can be performed. The thresholds Th(B) and Th(C) may be either the same values or different values.

In a case in which it is determined that a lane change cannot be performed, the target locus generator 144 newly selects two other vehicles among a plurality of other vehicles running in the adjacent lane L2 and resets a lane change target position TAs between the two other vehicles that have newly been selected. One vehicle out of two other vehicles that have newly been selected may be other vehicle that has been selected in the previous time.

The target locus generator 144 repeats to set a lane change target position TAs until it is determined that a lane change can be performed. At this time, the target locus generator 144 may generate a target locus for causing the subject vehicle M to wait on the running lane L1 or generate a target locus for deceleration or acceleration for moving the subject vehicle M to the lateral side of the lane change target position TAs on the running lane L1.

In the following description, a situation in which waiting for an ALC is performed due to the time-to-collision TTC(B) being shorter than the threshold Th(B) and the time-to-collision TTC(C) being shorter than the threshold Th(C) will be referred to as a “second situation,” a situation in which waiting for an ALC is performed due to the time-to-collision TTC(B) being shorter than the threshold Th(B) will be referred to as a “third situation,” and a situation in which waiting for an ALC is performed due to the time-to-collision TTC(C) being shorter than the threshold Th(C) will be referred to as a “fourth situation.” The process of waiting for an ALC is one example of “a process for searching for a space accompanying a lane change.”

In a case in which it is determined that a lane change can be performed, the target locus generator 144 outputs information representing a generated target locus to the second controller 160.

In a case in which it is determined that a lane change can be performed, the second controller 160 executes an ALC. The second controller 160 causes the subject vehicle M to change the lane to an adjacent lane on a side directed by a vehicle occupant by controlling the running driving force output device 200, the brake device 210, and the steering device 220 without being dependent on an operation (steering control) on a steering wheel from a vehicle occupant. The second controller 160 controls the running driving force output device 200, the brake device 210, and the steering device 220 such that the subject vehicle passes through sampling points on the generated target locus. The second controller 160 may set time-series target values of a speed in a horizontal direction (a lane width direction), a yaw rate, a turning angle, and the like while causing the speed to approach a desired speed pattern by controlling the running driving force output device 200 or the brake device 210 and may perform control of the steering device 220 such that the speed and the like approach the target values thereof.

The desired speed pattern may be a speed pattern for continuation of a constant speed or may be a speed pattern that is set such that acceleration/deceleration is performed in accordance with the progress of a lane change.

In the following description, a situation in which an ALC is executed will be referred to as a “fifth situation.” A state in which an ALC is executed is one example of “in the middle of a lane change.”

Referring back to FIG. 1, the display controller 190 causes the display device 70 to display a notification image IM on the basis of a state of the ALC according to the action plan generator 140 and the second controller 160. The notification image IM is an image used for notifying a vehicle occupant of the subject vehicle M of execution of the ALC. Hereinafter, details of a notification image IM that is caused to be displayed by the display device 70 by the display controller 190 in each situation will be described.

### [First Notification Image: Notification of Plan of ALC]

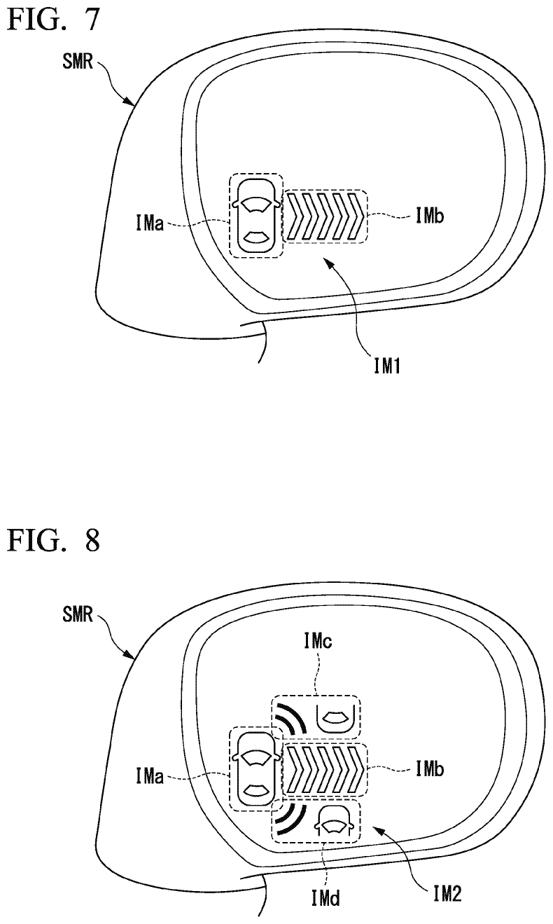

Hereinafter, details of a notification image IM caused to be displayed by the display device 70 by the display controller 190 in a first situation will be described. FIG. 7 is a diagram showing one example of a first notification image IM1. The first notification image IM1 is a notification image IM that notifies an observer of the right side mirror SMR that the subject vehicle M is in the state of planning an ALC in the “first situation.” As shown in FIG. 7, for example, an image IMa representing the subject vehicle M and an image IMb representing a direction in which the subject vehicle M will move through the ALC (in this case, to the right side) are included in the first notification image IM1. In a case in which control performed by the action plan generator 140 or the second controller 160 is the “first situation,” the display controller 190 causes the display device 70 to display the first notification image IM1. Accordingly, the automated driving control device 100 can allow a vehicle occupant of the subject vehicle M and a vehicle occupant of a rear reference vehicle to prepare for the ALC of the subject vehicle M.

[Second Notification Image to Fourth Notification Image: Notification from Waiting for ALC to Starting of ALC]

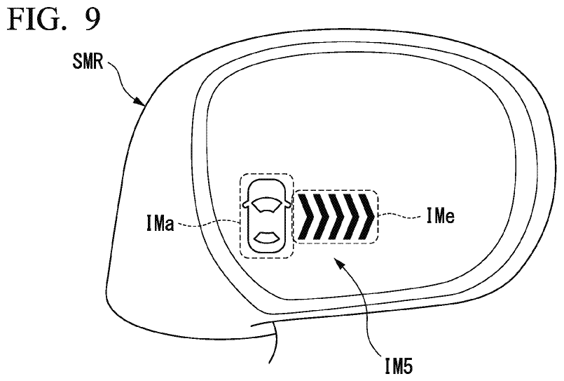

FIG. 8 is a diagram showing one example of a second notification image IM2. The second notification image IM2 is a notification image IM used for notifying an observer of the right side mirror SMR that the subject vehicle M cannot execute an ALC due to a front reference vehicle (other vehicle m2) and a rear reference vehicle (other vehicle m3) and is in the state of waiting in a “second situation.” As shown in FIG. 8, for example, an image IMa, an image 1 Mb, and an image IMc representing a front reference vehicle that is a cause for not being able to execute an ALC, and similarly, an image IMd representing a rear reference vehicle that is also a cause are included in the second notification image IM2. In a case in which control performed by the action plan generator 140 or the second controller 160 is the “second situation,” the display controller 190 causes the display device 70 to display the second notification image IM2.

In this way, the automated driving control device 100 can notify a vehicle occupant of the rear reference vehicle that the subject vehicle M is in the state of waiting for a lane change due to the front reference vehicle and the rear reference vehicle.

A third notification image IM3 (not shown in the drawing) is a notification image IM that is used for notifying an observer of the right side mirror SMR that the subject vehicle M cannot execute an ALC due to the front reference vehicle (other vehicle m2) and is in the state of waiting in a “third situation.” An image IMa, an image 1 Mb, and an image IMc are included in the third notification image IM3. In a case in which control performed by the action plan generator 140 or the second controller 160 is the “third situation,” the display controller 190 causes the display device 70 to display the third notification image IM3.

In this way, the automated driving control device 100 can notify a vehicle occupant of the rear reference vehicle that the subject vehicle M is in the state of waiting for a lane change due to the front reference vehicle.

A fourth notification image IM4 (not shown in the drawing) is a notification image IM used for notifying an observer of the right side mirror SMR that the subject vehicle M cannot execute an ALC due to a rear reference vehicle (other vehicle m3) and is in the state of waiting in a “fourth situation.” An image IMa, an image IMb, and an image IMd are included in the fourth notification image IM4. In a case in which control performed by the action plan generator 140 or the second controller 160 is a “fourth situation,” the display controller 190 causes the display device 70 to display the fourth notification image IM4.

In this way, the automated driving control device 100 can notify a vehicle occupant of a rear reference vehicle that the subject vehicle M is in the state of waiting for a lane change due to the rear reference vehicle.

### [Fifth Notification Image: Notification of Execution of ALC]

FIG. 9 is a diagram showing one example of a fifth notification image IM5. The fifth notification image IM5 is a notification image IM used for notifying an observer of the right side mirror SMR of a state in which an ALC is being executed in the subject vehicle M in a “fifth situation.” An image IMe in which a direction in which the subject vehicle M will move through the ALC is emphasized more than in an image IMa and an image IMb are included in the fifth notification image IM5. In a case in which control performed by the action plan generator 140 or the second controller 160 is a “fifth situation,” the display controller 190 causes the display device 70 to display the fifth notification image IM5.

The first notification image IM1 to the fifth notification image IM5 are one example of images having “different display forms from each other.” The images IMa to IMe included in the first notification image IM1 to the fifth notification image IM5 may be represented in colors defined in advance as notification colors relating to automated driving control.

### [End of Notification]

In a case in which a lane change has been completed in accordance with an ALC, the display controller 190 causes the display device 70 to end the display of the fifth notification image IM5. In the “first situation” to the “fourth situation,” in a case in which a predetermined time has elapsed (it has reached a time-out time), the display controller 190 regards the situation as a situation in which it is difficult to perform ALC control based on an instruction and causes the display device 70 to end the display of the first notification image IM1 to the fourth notification image IM4.

The display controller 190 may cause the display device 70 to display a notification image IM used for notifying an observer of the right side mirror SMR of time-out. The automated driving control device 100 may turn on a turn indicator while the display controller 190 simultaneously causes the display device 70 to display the notification image IM.

### [Operation of Automated Driving Control Device 100]

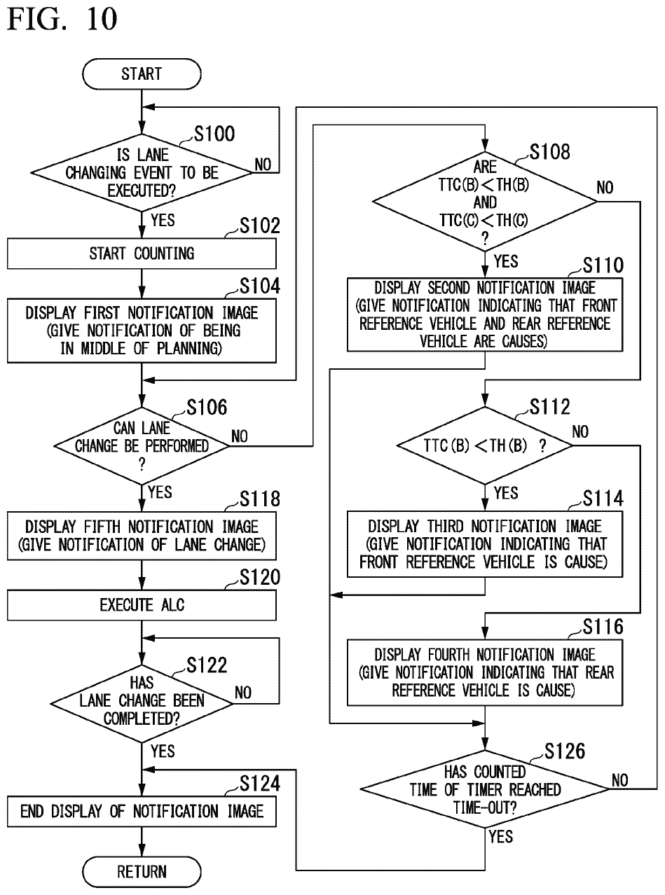

Hereinafter, the operation of the automated driving control device 100 will be described with reference to FIG. 10. FIG. 10 is a flowchart showing one example of the flow of the operation of the automated driving control device 100 according to the first embodiment. First, the target locus generator 144 determines whether or not execution of a lane changing event has been determined by the event determiner 142 (Step S100). The target locus generator 144 waits until execution of a lane changing event is determined by the event determiner 142. In a case in which execution of a lane changing event has been determined by the event determiner 142, the target locus generator 144 starts an ALC toward a side to which the subject vehicle will move through the ALC and starts counting of a timer (Step S102). Next, the target locus generator 144 causes the display device 70 to display the first notification image IM1 used for giving a notification of a state in which an ALC is planned (in other words, the “first situation”) (Step S104).

Next, the target locus generator 144 determines whether or not a lane change toward a side to which the subject vehicle will move through an ALC can be performed (Step S106). In a case in which it is determined that a lane change to a side to which the subject vehicle will move through the ALC cannot be performed, the target locus generator 144 determines whether or not the cause is a front reference vehicle and a rear reference vehicle (in other words, “second situation”: time-to-collision TTC(B)<threshold Th(B) and time-to-collision TTC(C)<threshold Th(C)) (Step S108).

In a case in which it is determined that the causes are the front reference vehicle and the rear reference vehicle, the target locus generator 144 causes the display device 70 to display the second notification image IM2 (Step S110). Next, the target locus generator 144 causes the process to proceed to Step S126.

In a case in which it is determined that the cause for not being able to perform a lane change to a side to which the subject vehicle will move through an ALC is neither a front reference vehicle nor a rear reference vehicle, the target locus generator 144 determines whether or not the cause is the front reference vehicle (in other words, “third situation”: time-to-collision TTC(B)<threshold Th(B)) (Step S112). In a case in which it is determined that the cause is the front reference vehicle, the target locus generator 144 causes the display device 70 to display the third notification image IM3 (Step S114). Next, the target locus generator 144 causes the process to proceed to Step S126.

In a case in which it is determined that the cause for not being able to perform a lane change to a side to which the subject vehicle will move through an ALC is not the front reference vehicle, the target locus generator 144 regards the cause as being the rear reference vehicle (in other words, “fourth situation”: time-to-collision TTC(C)<threshold Th(C)) and causes the display device 70 to display the fourth notification image IM4 (Step S116). Next, the target locus generator 144 causes the process to proceed to Step S126.

In a case in which a lane change to a side to which the subject vehicle will move through an ALC can be performed (in other words, the “fifth situation”), the target locus generator 144 causes the display device 70 to display the fifth notification image IM5 (Step S118). Next, the target locus generator 144 executes the ALC and performs a lane change of the subject vehicle M (Step S120). The target locus generator 144 determines whether or not the lane change of the subject vehicle M has been completed (Step S122). In a case in which it is determined that the lane change of the subject vehicle M has been completed, the target locus generator 144 causes the display device 70 to end the display of the notification image IM (Step S124).

After causing the display device 70 to display the second notification image IM2 to the fourth notification image IM4 in Steps S110, S114, and S116, the target locus generator 144 determines whether or not a counted time of the timer has reached a time-out time after starting to count the timer in Step S102 (Step S126). In a case in which it is determined that the counted time has not reached the time-out time, the target locus generator 144 causes the process to proceed to Step S106. On the other hand, in a case in which it is determined that the counted time has reached the time-out time, the target locus generator 144 causes the process to proceed to Step S124.

### Summary of First Embodiment

As described above, the display controller 190 of the automated driving control device 100 according to this embodiment, by causing the display device 70 to display the first notification image IM1 to the fifth notification image IM5 in accordance with the state of the ALC according to the action plan generator 140 or the second controller 160, can perform automated driving prompting a driver of a vehicle to perform monitoring of the surroundings while giving a feeling of security to an observer of the side mirror SM (for example, a vehicle occupant of the subject vehicle M or a vehicle occupant of the other vehicle m running behind the subject vehicle M). The first notification image IM1 to the fifth notification image IM5 caused to be displayed by the display device 70 by the display controller 190 are images that are different from each other. Accordingly, the automated driving control device 100 according to this embodiment can present information to an observer more easily.

### Second Embodiment

Hereinafter, a second embodiment will be described. In the first embodiment, a case in which the notification image IM is displayed on the side mirror SM when automated driving control of the subject vehicle M is performed has been described. In the second embodiment, a case in which a notification image IM is displayed on the side mirror SM when driving support control of a subject vehicle M is performed will be described. The same reference numerals will be assigned to components similar to those of the embodiment described above, and description thereof will be omitted.

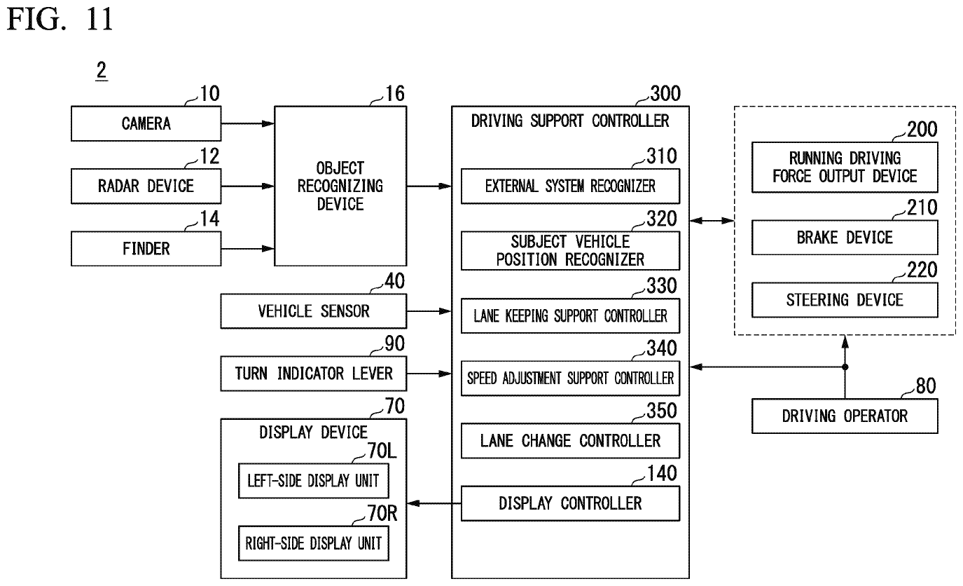

FIG. 11 is a configuration diagram of a vehicle control system 2 according to the second embodiment. The vehicle control system 2, for example, includes a camera 10, a radar device 12, a finder 14, an object recognizing device 16, a vehicle sensor 40, a display device 70, a driving operator 80, a turn indicator lever 90, a running driving force output device 200, a brake device 210, a steering device 220, and a driving support controller 300. The turn indicator lever 90, for example, gives an instruction for operating a direction indicator and functions as a switch used for giving an instruction for an automated lane change (hereinafter referred to as lane change assist (LCA)) in a predetermined case. Here, the predetermined case, for example, is a case in which lane keeping support control (hereinafter referred to as a lane keeping assist system (LKAS) and speed adjustment support control (hereinafter referred to as adaptive cruise control (ACC)) are operating. As a switch used for giving an instruction for LCA, a switch according to another aspect may be used.

The driving support controller 300 includes an external system recognizer 310, a subject vehicle position recognizer 320, a lane keeping support controller 330, a speed adjustment support controller 340, a lane change controller 350, and a display controller 190. Some or all of such constituent elements are each realized by a hardware processor such as a CPU executing a program (software). Some or all of such constituent elements may be realized by hardware (including a circuit unit) such as an LSI, an ASIC, an FPGA, or a GPU or may be realized by software and hardware in cooperation. The external system recognizer 310 and the subject vehicle position recognizer 320 are one example of a “recognizer” and have a function similar to that of the recognizer 130 according to the first embodiment.

The lane keeping support controller 330 controls the steering device 220 such that the subject vehicle keeps its own lane recognized by the subject vehicle position recognizer 320. For example, the lane keeping support controller 330 controls the steering of the subject vehicle M such that the subject vehicle M runs at the center of its own lane. Hereinafter, driving support control for controlling the subject vehicle such that it runs at the center of its own lane will be described as “lane keeping support control.”

In a case in which the subject vehicle M is running at a position deviated to either of the left and right from the center of its own lane, the lane keeping support controller 330 performs road deviation inhibition control. For example, the lane keeping support controller 330 performs the following control as road deviation inhibition control.

For example, in a case in which the subject vehicle M is close to a partition line LM, the lane keeping support controller 330 vibrates a steering wheel until a distance between the partition line LM partitioning the own lane and the subject vehicle M becomes equal to or shorter than a predetermined distance, thereby prompting a vehicle occupant to pay attention. At this time, a HMI controller causes various display devices of the HMI 20 to display images or outputs speech and the like from a speaker, thereby notifying a vehicle occupant that the subject vehicle M is likely to deviate from its own lane. After vibrating the steering wheel, in a case in which there is no operation of a vehicle occupant on the steering wheel (in a case in which a steering angle or a steering torque is less than a threshold), the lane keeping support controller 330, by controlling the steering device 220, controls steering such that the direction of the steering wheel is changed to the lane center side, and the subject vehicle M returns to the lane center side.

The speed adjustment support controller 340, for example, controls the running driving force output device 200 and the brake device 210 such that the subject vehicle M follows a nearby vehicle within a predetermined distance (for example, about 50 [m]) (hereinafter, referred to as a preceding vehicle) in front of the subject vehicle M among nearby vehicles recognized by the external system recognizer 310 and accelerates or decelerates the subject vehicle M within the range of set vehicle speeds (for example, 50 to 100 [km/h]) determined in advance. Here, “following,” for example, is a running form in which a constant relative distance (inter-vehicle distance) between the subject vehicle M and a preceding vehicle is maintained. Hereinafter, driving support control for supporting the running of the subject vehicle M in such a running form will be referred to as “following running support control.” In a case in which a preceding vehicle has not been recognized by the external system recognizer 310, the speed adjustment support controller 340 may simply cause the subject vehicle M to run within the range of the set vehicle speeds.

For example, when an instruction for performing LCA is performed by a vehicle occupant, the lane change controller 350 starts to operate. The instruction for LCA, for example, is performed by operating the turn indicator lever 90. When the turn indicator lever 90 is operated in any one direction for a predetermined time or more, the lane change controller 350 executes LCA to a lane on the side to which it was operated. For example, the lane change controller 350 may have an LCA start condition that both the LKAS and the ACC are operating. The reason for this is that, in order to realize smooth LCA, it is preferable for the behavior of the vehicle at a start time point to be stably maintained.

The lane change controller 350 determines whether or not a lane change to a lane on a side to which the LCA has been instructed can be performed. For example, in a case in which LCA start conditions such as a condition that no obstacle such as other vehicle be present in a lane that is a lane change destination, a condition that a partition line LM partitioning a lane that is a lane change destination and its own lane not be a road mark representing prohibition of a lane change (prohibition of run-over), a condition that a lane that is a lane change destination be recognized, a condition that the road not be a curved road, a condition that another driving support control having a priority level higher than that of the LCA not be performed, and a condition that a predetermined time or more have elapsed from the start of operations of the LKAS and the ACC are satisfied, the lane change controller 350 executes the LCA. Here, another driving support control having a priority level higher than that of the LCA, for example, is control for urgently avoiding an obstacle.

Hereinafter, details of the LCA will be described. The lane change controller 350 sets a lane change target position TAs in an adjacent lane by a process similar to that of the target locus generator 144 described above. Next, the lane change controller 350 controls the running driving force output device 200 and the brake device 210 on the basis of a recognition result acquired by the external system recognizer 310 and accelerates or decelerates the subject vehicle M such that the vehicle speed becomes a set vehicle speed determined in advance.

Next, in a case in which a time-to-collision TTC(B) and a time-to-collision TTC(C) acquired through a process similar to that of the target locus generator 144 described above satisfy the conditions (in other words, in a case in which a lane change can be performed), the lane change controller 350 acquires a steering angle for movement to the lane change target position TAs on the basis of a recognition result acquired by the subject vehicle position recognizer 320 and controls the steering device 220 on the basis of the acquired steering angle. In this way, the lane change controller 350 causes the subject vehicle M to perform a lane change to the lane change target position TAs.

On the other hand, in a case in which the time-to-collision TTC(B) or the time-to-collision TTC(C) does not satisfy the conditions (in other words, in a case in which a lane change cannot be performed), the lane change controller 350 does not control the steering device 220 and waits until the conditions are satisfied. In a case in which a state in which the conditions are not satisfied continues for a predetermined time or more, the lane change controller 350 may time-out and cancel the LCA.

The display controller 190 causes the display device 70 to display a notification image IM on the basis of the state of the LCA according to the lane change controller 350. The situations (the first situation to the fifth situation) occurring in accordance with the state of the ALC according to the action plan generator 140 and the second controller 160 described above and situations occurring in accordance with the state of the LCA according to the lane change controller 350 are similar to each other, and thus description of the display controller 190 according to the second embodiment will be omitted.

### Summary of Second Embodiment

As described above, in the driving support controller 300 according to this embodiment, the display controller 190 causes the display device 70 to display the first notification image IM1 to the fifth notification image IM5 in accordance with the state of LCA according to the lane change controller 350, whereby automated driving prompting a driver of the vehicle to monitor the surroundings can be performed while giving an observer of the side mirror SM (for example, a vehicle occupant of the subject vehicle M or a vehicle occupant of the other vehicle m running behind the subject vehicle M) a feeling of security.

### Modified Example

Hereinafter, a modified example of each embodiment will be described. In the first embodiment and the second embodiment, a case in which the display controller 190 provides various kinds of information for an observer of the side mirror SM by causing the display device 70 to display a notification image IM has been described. In the modified example, a case in which the display controller 190 provides various kinds of information for an observer of the side mirror SM through turning on/off of light will be described. The same reference sign will be assigned to a component similar to that of the embodiment described above, and description thereof will not be presented here.

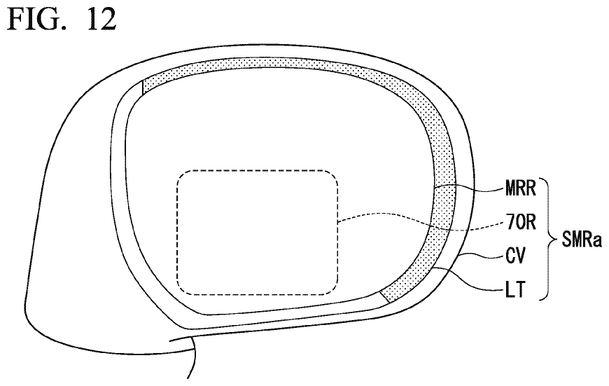

FIG. 12 is a diagram showing one example of the configuration of a right side mirror SMRa according to a modified example. The right side mirror SMRa includes a illuminator LT in addition to the components included in the right side mirror SMR. The illuminator LT, for example, is realized by a light emitting diode (LED) and is disposed in a part or the whole of the circumference of an outer edge of the mirror part MRR. The illuminator LT is turned on or off on the basis of control of the display controller 190.

The display controller 190, for example, instead of operating in the same manner as that of the turn indicator, is turned on in accordance with a lighting form corresponding to each of the first situation to the fifth situation and further emphasizes the display of the display device 70. In this way, the driving support controller 300 according to the modified example can allow an observer of the right side mirror SMR to be easily aware of presentation of various kinds of information using the display device 70. The display controller 190, for example, is realized by configuring lighting forms corresponding to situations to be different from each other in the speed of turning on, a timing of turning on/off, or a lighting color. The automated driving control device 100 or the driving support controller 300 may turn on the turn indicator simultaneously when the display controller 190 turns on the illuminator LT.

In this way, the display controller 190 can notify a vehicle occupant of the subject vehicle M and a vehicle occupant of a rear reference vehicle of a cause of the subject vehicle M waiting for a lane change by turning on the illuminator LT in a different lighting form. As a result, even in a surrounding environment in which it is difficult for a vehicle occupant of a rear reference vehicle to see the display of the display device 70 (for example, in heavy rain, during daytime, or the like), the display controller 190 can notify the vehicle occupant of the state of the lane change.

### [Hardware Configuration]

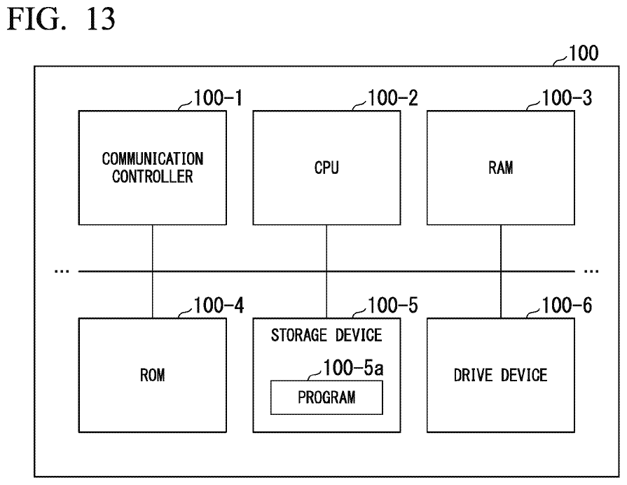

FIG. 13 is a diagram showing one example of the hardware configuration of the automated driving control device 100 or the driving support controller 300 (hereinafter, simply referred to as the device 100). As shown in the drawing, the device 100 has a configuration in which a communication controller 100-1, a CPU 100-2, a random access memory (RAM) 100-3 used as a working memory, a read only memory (ROM) 100-4 storing a boot program and the like, a storage device 100-5 such as a flash memory or a hard disk drive (HDD), a drive device 100-6, and the like are interconnected through an internal bus or a dedicated communication line. The communication controller 100-1 communicates with constituent elements other than the automated driving control device 100. A program 100-5a executed by the CPU 100-2 is stored in the storage device 100-5. This program is expanded into the RAM 100-3 by a direct memory access (DMA) controller (not shown in the drawing) or the like and is executed by the CPU 100-2. In this way, some or all of the recognizer 130, the action plan generator 140, the second controller 160, the external system recognizer 310, the subject vehicle position recognizer 320, the lane keeping support controller 330, the speed adjustment support controller 340, and the lane change controller 350 are realized.

The embodiment described above can be represented as below.

A vehicle control device that includes a storage device storing a program, a hardware processor, and a side mirror that reflects an image of a landscape of a rear side of a vehicle including an adjacent lane adjacent to an own lane in which the vehicle is running and allows a vehicle occupant of the vehicle to visually recognize the image, and the hardware processor, by executing the program stored in the storage device, is configured to recognize a surrounding environment of the vehicle, perform lane change control of the vehicle by controlling at least steering of the vehicle, and display a notification image used for notifying execution of the lane change control on the display.

While preferred embodiments of the invention have been described and shown above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A vehicle control device comprising:
a surrounding recognizer that is configured to recognize a surrounding environment of a vehicle;
a lane change controller that is configured to perform lane change control of the vehicle by controlling at least steering of the vehicle;
a side mirror that is configured to reflect an image of a landscape of a rear side of the vehicle including an adjacent lane adjacent to an own lane in which the vehicle is running and allows a vehicle occupant of the vehicle to visually recognize the image;
a display unit that is disposed in the side mirror; and
a display controller that is configured to cause the display unit to display a notification image used for giving a notification of execution of the lane change control.

2. The vehicle control device according to claim 1, wherein the display controller is configured to cause the display unit to display the notification image at a timing at which the lane change control is performed by the lane change controller.

3. The vehicle control device according to claim 1, wherein the display controller is configured to cause the display unit to display a first notification image representing that a lane change is planned, a second notification image representing a space searching process accompanying the lane change, and a third notification image representing being in the middle of the lane change in mutually different display forms.

4. The vehicle control device according to any one of claim 1, further comprising a illuminator that is disposed in an outer edge of the side mirror,
wherein the display controller is configured to give a notification of the lane change of the vehicle by turning the illuminator on.

5. A vehicle control method using a computer mounted in a vehicle including a side mirror that is configured to reflect an image of a landscape of a rear side of the vehicle including an adjacent lane adjacent to an own lane in which the vehicle is running and allows a vehicle occupant of the vehicle to visually recognize the image and a display unit that is disposed in the side mirror, the vehicle control method comprising:
recognizing a surrounding environment of the vehicle;
performing lane change control of the vehicle by controlling at least steering of the vehicle; and
causing the display unit to display a notification image used for giving a notification of execution of the lane change control.

6. A storage medium having a program stored thereon, the program causing a computer mounted in a vehicle including a side mirror that is configured to reflect an image of a landscape of a rear side of the vehicle including an adjacent lane adjacent to an own lane in which the vehicle is running and allows a vehicle occupant of the vehicle to visually recognize the image and a display unit that is disposed in the side mirror and executes:
recognizing a surrounding environment of the vehicle;
performing lane change control of the vehicle by controlling at least steering of the vehicle; and
causing the display unit to display a notification image used for giving a notification of execution of the lane change control.
